(19) United States
(12) Patent Application Publication
(10) Pub. No.: US 2010/0131463 A1
(43) Pub. Date: May 27, 2010

(54) MOBILE OBSERVATION MANAGEMENT SOLUTIONS

(75) Inventors: Clifford Smeed, San Diego, CA (US); Paul West, San Diego, CA (US); Ricardo Flores, San Diego, CA (US); Jason Keller, San Diego, CA (US); Francisco Tucker, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: SHAREPOINT360, LLC, San Diego, CA (US)

(21) Appl. No.: 12/624,347

(22) Filed: Nov. 23, 2009

Related U.S. Application Data
(60) Provisional application No. 61/117,035, filed on Nov. 21, 2008.
(60) Provisional application No. 61/170,041, filed on Apr. 16, 2009.

(51) Int. Cl. G06F 17/30; G06F 17/20; G06F 3/048

(52) U.S. Cl. 707/610; 706/11; 707/E17.005; 707/687; 715/709

(57) ABSTRACT

Managing mobile observation, including: customizing observation data collection including generating customized observation questions to meet particular needs of a client; dynamically building user-generated questions in both a web application and a mobile application in such an input form as to match the customized observation questions; collecting mobile observation data; and resolving conflicts in the observation data by synchronizing data residing in multiple locations.

### CROSS-REFERENCE TO RELATED APPLICATIONS

This application claims the benefit of priority under 35 U.S.C. §119(e) of co-pending U.S. Provisional Patent Application No. 61/117,035, filed Nov. 21, 2008, entitled “Mobile Observation Management Solutions,” and co-pending U.S. Provisional Patent Application No. 61/170,041, filed Apr. 16, 2009, entitled “Mobile Inspection and Observations.” The disclosures of the above-referenced applications are incorporated herein by reference.

### BACKGROUND

1. Field of the Invention

The present invention relates to solutions to mobile observation management, and more specifically, to field observations such as completion of forms, interviews, data capture, media capture, and inspections of objects.

2. Background

A number of businesses are dependent on information observed and/or collected from sources that are mobile and/or outside of the office settings. These types of information are sometimes referred to as “mobile observation data,” which carry with it an inherent list of complexities. Collecting, transmitting, manipulating and centralizing data as a result of “mobile observations” are coupled with additional complexities and difficulties of analyzing and understanding the centralized data.

### SUMMARY

In one implementation, a method of managing mobile observation is disclosed. The method includes: customizing observation data collection including generating customized observation questions to meet particular needs of a client; dynamically building user-generated questions in both a web application and a mobile application in such an input form as to match the customized observation questions; collecting mobile observation data; and resolving conflicts in the observation data by synchronizing data residing in multiple locations.

In another implementation, a system for mobile observation management is disclosed. The system includes: a data collection customization module to allow a user to generate customized observation questions to meet particular needs of the user; a dynamic rendering engine to dynamically build user-generated questions in both a web application and a mobile application in such an input form as to match the observation questions that are being asked; and a conflict resolution module to resolve conflicts in the data collected or entered by synchronizing data residing in multiple locations.

In another implementation, a computer-readable storage medium storing a computer program for managing mobile observation is disclosed. The computer program includes executable instructions that cause a computer to: customize observation data collection including generating customized observation questions to meet particular needs of a client; dynamically build user-generated questions in both a web application and a mobile application in such an input form as to match the customized observation questions; collect mobile observation data; and resolve conflicts in the observation data by synchronizing data residing in multiple locations.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a functional block diagram of a mobile observation management system in accordance with one implementation of the present invention.

FIG. 2 shows a synchronization protocol used to resolve conflicts in the data collected or entered by synchronizing data residing in multiple locations.

FIG. 3 is a flowchart implementing a mobile observation management technique in accordance with one implementation of the present invention.

FIG. 4A illustrates a representation of a computer system and a user.

FIG. 4B is a functional block diagram illustrating the computer system hosting the mobile observation management applications.

FIG. 5 is a detailed block diagram of a mobile observation management system in accordance with one particular implementation of the present invention.

FIG. 6A shows the details of the network file storage (NFS).

FIG. 6b shows the details of the central administration database (DB) hosting.

FIG. 6C shows the details of the client database hosting.

### DETAILED DESCRIPTION

Certain implementations as disclosed herein provide techniques for managing mobile observation process including mobile observation data. Mobile observation may include completion of forms, interviews, data capture, media capture, and inspections of objects. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

Currently, the mobile observation data (e.g., field inspection data) can be collected by various methods. For example, a data collection process may involve a field operator collecting and entering data based on a series of pre-made questions generated for a standardized inspection process. In another example, a data collection and entry process may involve collecting and entering data into a mobile device, and later re-entering the collected data into a central database system. In other methods, after data has been collected, it is typically processed and manipulated manually. However, manual processing and manipulation can cause errors and inconsistencies, which may incur additional time and cost. Moreover, data collected during observations or inspections typically should be entered and/or downloaded immediately but there may be delays in inputting the collected data, which may be hours, days, weeks, or even longer. Further, the current process of collecting mobile observation data does not provide the ability to relate additional data to the data collected.

Implementations of the present invention provide solutions to above-described difficulties in current management of mobile observation process. In one implementation, the mobile device is prepared (before the observation data is entered into it) by establishing a network connection with a synchronization protocol which would allow the data to be entered once and synchronized according to the priority levels. In another implementation, to address the inflexibility in the data collection process where the data collection is based on a series of pre-made questions generated for a standardized inspection process, users are allowed to generate relevant observation (e.g., inspection) questions or form-based questions to meet the unique requirements of the users.

In another implementation, user-generated questions are dynamically built in both the web application and the mobile application in an input form corresponding to the matching questions. For example, if a user-generated question requests an inspector to take a picture of a particular inspection site, the system will expect the user to provide image(s) or video as an input/reply to the question. That is, each question is prepared in real-time to match the expected answer.

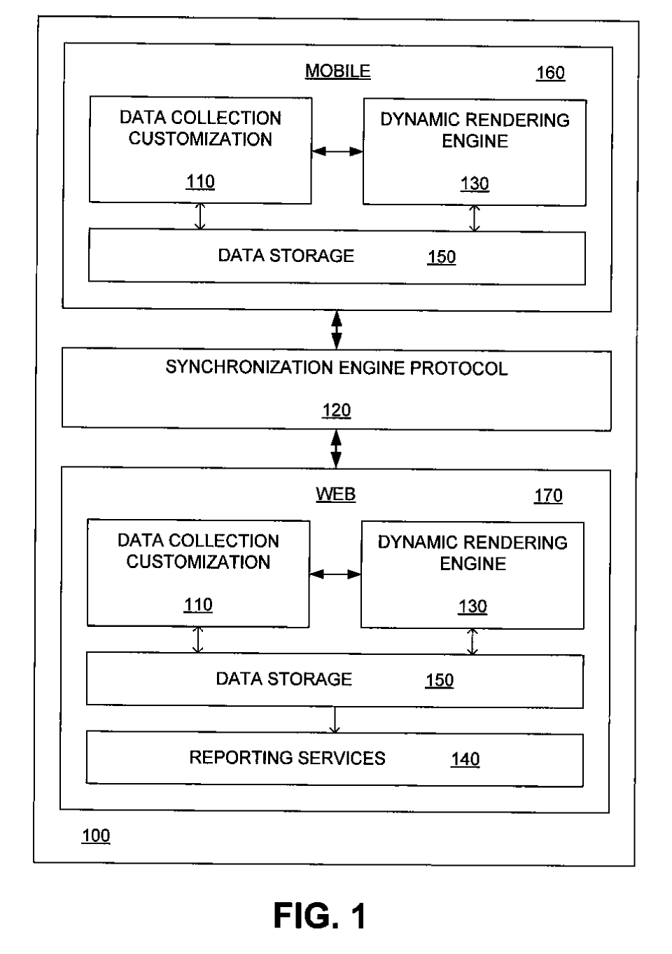

FIG. 1 is a functional block diagram of a mobile observation management system 100 in accordance with one implementation of the present invention. The management system 100 includes two substantially similar systems in a mobile application 160 and a web application 170. Each application 160 or 170 includes a data collection customization module 110, a dynamic rendering engine 130, and data storage 150. The web application 170 also includes reporting services 140. The mobile application 160 and the web application 170 are coupled to each other through a synchronization engine protocol 120.

In one implementation, the data collection customization module 110 is configured to allow the user to generate customized observation questions or form-based questions to meet the particular needs. The customization module 110 employs wizard controls and graphical interfaces in the form of flow charts to generate customized observation (e.g., inspection) questions. Further, the data collection customization module 110 uses a decision-based question layout that dynamically generates follow-up questions based on answers to the previous questions. This decision-based question layout provides a much quicker and more efficient way of asking relevant questions to extract comprehensive observation data.

In the illustrated implementation of FIG. 1, the data collection customization module 110 interfaces with or works in conjunction with the dynamic rendering engine 130, which dynamically builds user-generated questions in both the web application and the mobile application in such an input form as to match the questions that are being asked. For example, as described above, if a user-generated question requests an observer or inspector to take a picture of a particular observation or inspection site, the system will expect the user to provide image(s) or video as an input or reply to the question. That is, each question is prepared in real-time to match the expected answer.

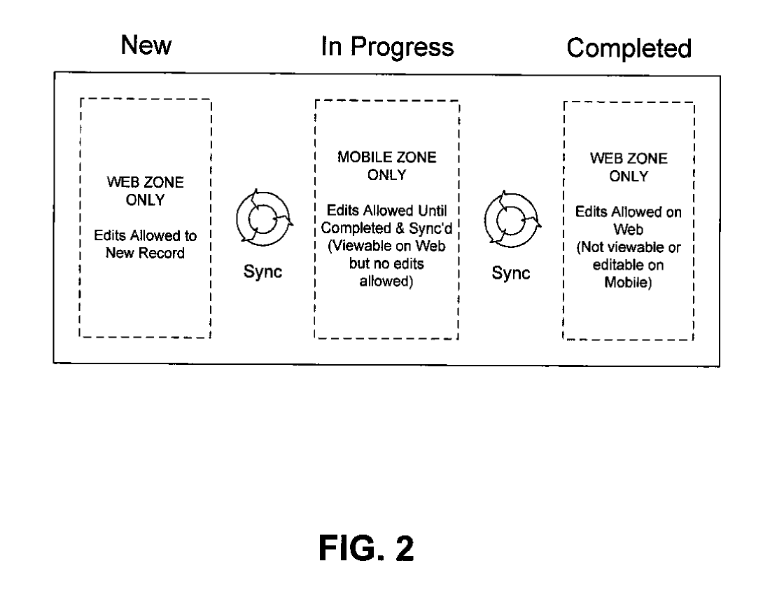

The data collection customization module 110 also works in conjunction with the synchronization engine protocol 120 (sometimes referred to as “a conflict resolution module”) to resolve conflicts in the data collected or entered by synchronizing data residing in multiple locations. In one implementation, the synchronization engine protocol 120 allows the data to be entered once and synchronized according to the priority levels. As shown in FIG. 2, the integrity of the observation data is maintained by allowing edit record zones in only one area at a time. The synchronization engine protocol 120 protects data so that it may only be used in one specified location at any one time. For example, data that is currently being worked in the field in a mobile zone (e.g., on a mobile device such as PDA) is visible to the manager in a web zone (e.g., through the web application), but can only be altered on the mobile device. This allows for mobile users to work in remote areas without having to worry about data being changed that may impact their work. Further, when the mobile user synchronizes the data back to the web application, there are no conflicts to which data is current and can be used by the system. This technique protects the observation data from multiple versioning and prevents conflicts in the data.

Referring again to FIG. 1, the reporting service 140 extracts observation data from the 150 data storage and prepares enterprise level reports using a “software as a service” deployment model for the mobile observation management application. This model allows licensing of the mobile observation management application to the users as a service on demand. Thus, the reporting service 140 provides reports specifically tailored to the identified users. Further, the reporting service 140 allows for anyone with proper permissions to view data and reports without having to login to a specific computer or request reports from others.

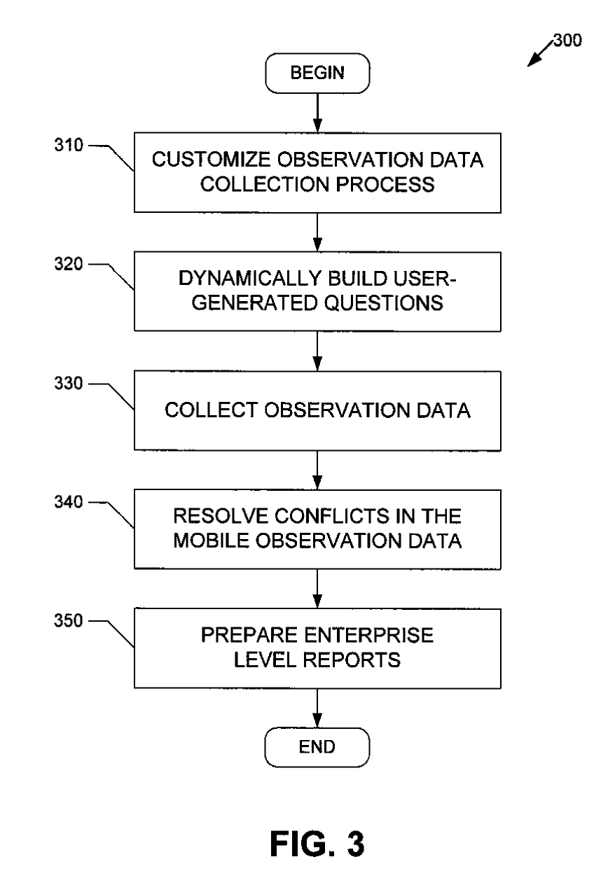

FIG. 3 is a flowchart 300 implementing a mobile observation management technique in accordance with one implementation of the present invention. The mobile observation management technique includes customizing observation data collection process, at box 310. In one implementation, customizing observation data includes generating customized observation questions or form-based questions to meet the particular needs of a client. The process may employ wizard controls and graphical interfaces in the form of flow charts to generate customized observation (e.g., inspection) questions. The customization of the observation data also involves using a decision-based question layout that dynamically generates follow-up questions based on answers to the previous questions. This decision-based question layout provides a much quicker and more efficient way of asking relevant questions to extract comprehensive observation data.

At box 320, user-generated questions are dynamically built in the web application and dynamically presented on the mobile application and web application in such an input form as to match the questions that are being asked. For example, as described above, if a user-generated question requests an observer or inspector to take a picture of a particular observation or inspection site, the system will expect the user to provide image(s) or video as an input or reply to the question. That is, each question is prepared in real-time to match the expected answer. Once the user-generated questions are built, at box 320, observation data is collected via the web application or mobile application, at box 330.

Conflicts are resolved in the mobile observation data collected or entered, at box 340, by synchronizing data residing in multiple locations. In one implementation, the data is entered once and synchronized according to the priority levels. As described above, the integrity of the observation data is maintained by allowing edit record zones in only one area at a time. The observation data is protected so that it may only be edited in one specified location at any one time. For example, data that is currently being worked in the field on a mobile device such as PDA is visible to the manager through the web application, but can only be altered on the mobile device. That is alteration of the observation data is allowed to be made at a location where the observation data is being entered. This allows for mobile users to work in remote areas without having to worry about data being changed that may impact their work. Further, when the mobile user synchronizes the data back to the web application, there are no conflicts to which data is current and can be used by the system. This technique protects the observation data from multiple versioning and prevents conflicts in the data.

Observation data is then extracted and enterprise level reports are prepared, at box 350, using a “software as a service” deployment model for the mobile observation management application. This model allows licensing of the mobile observation management application to the users as a service on demand. Thus, this deployment model allows specifically tailored reports to be provided to the identified users. Further, it allows anyone with proper permissions to view data and reports without having to login to a specific computer or request reports from others.

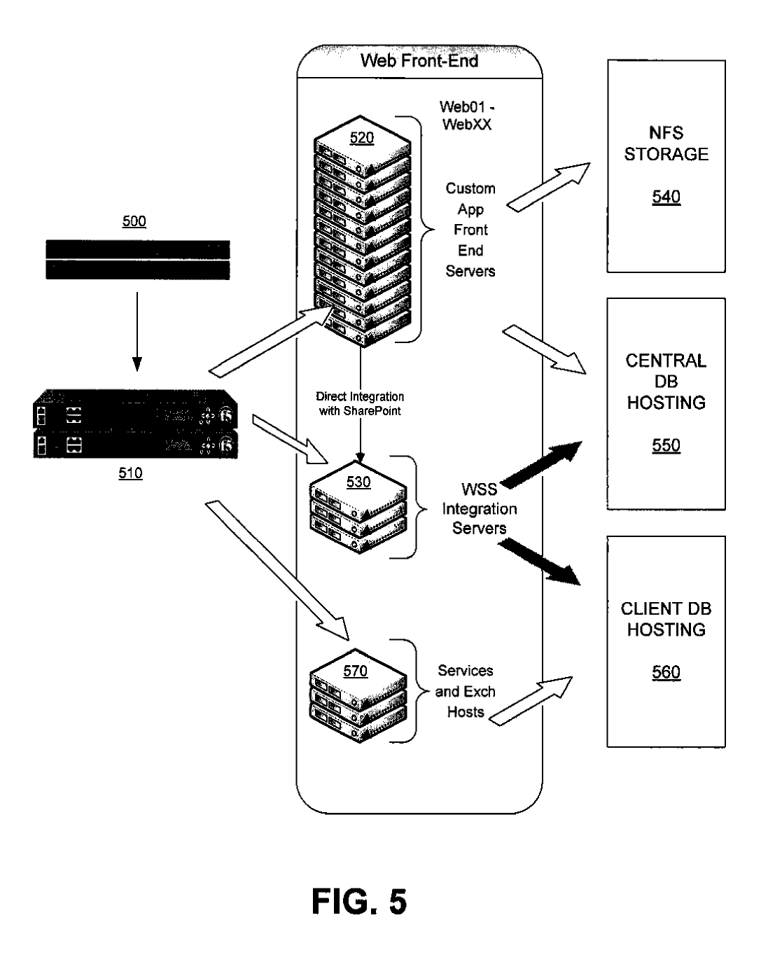

FIG. 5 is a detailed block diagram of a mobile observation management system in accordance with one particular implementation of the present invention. In this implementation, the observation management system is implemented as a “Mobile360” product. FIG. 5 shows a “Software as a Service” (SAAS) architecture for the Mobile360 product. This diagram shows the details of out how the SAAS architecture is constructed at a technical level.

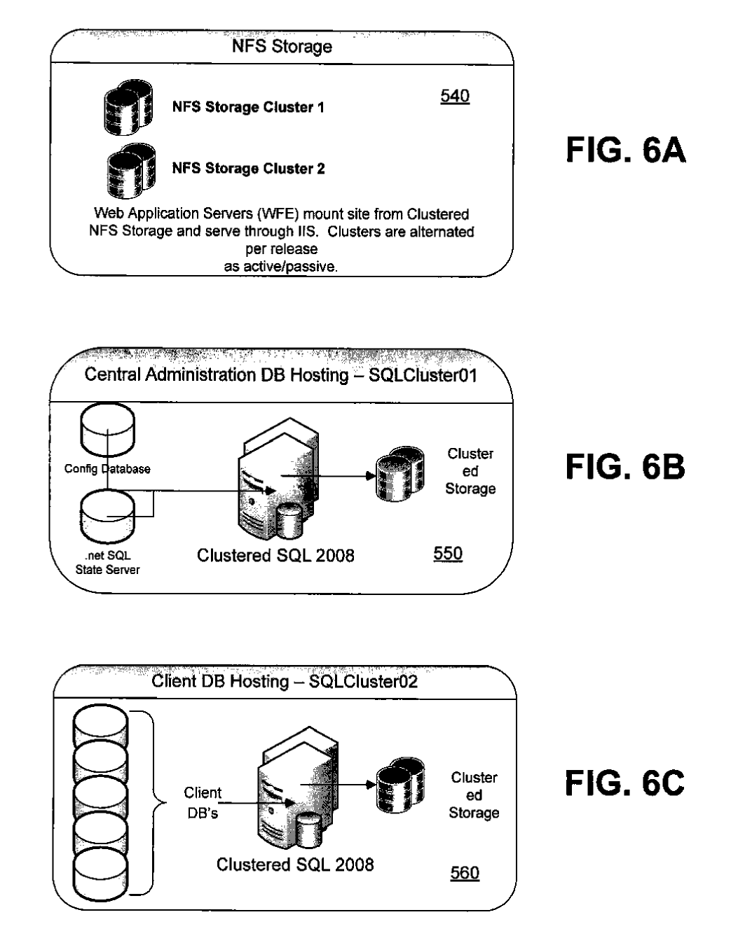

In the illustrated implementation of FIG. 5, the architecture includes a network switch 500, load balancers 510, a Web application pool 520, collaboration servers 530, network file storage (NFS) 540, a central administration database (DB) hosting 550, a client database hosting 560, and a services application pool 570. The details of the network file storage (NFS) 540, the central administration database (DS) hosting 550, and the client database hosting 560 are shown in detail in FIG. 6A, FIG. 63, and FIG. 6C, respectively.

In one implementation, the network switch 500 controls incoming and outgoing requests for data. The load balancers 510 routes traffic to the appropriate resource to serve up data. The load balancers 510 ensure that clients request for data are evenly distributed among system resources ensuring quick response times. The Web application pool 520 is a group of web servers running the Mobile360 platform. This ensures system availability and provides roll-over support if any system fails. The collaboration servers 530 are used to provide “SharePoint” or other connections to collaboration server integration. This ensures the ability to provide additional data and content management outside the scope of the M360 platform. The network file storage 540 includes the application that is then served to the Web application pool 520. This allows for seamless upgrades into the environment while providing redundancy and the ability to run concurrent versions of Mobile360. The central administration DB Hosting 550 provides information relating to the clients. The Web application pool 520 pulls predetermined settings for each client. The settings are stored in this area. The client database hosting 560 provides database for each Mobile360 client in that each client has its own unique database. These databases store all content and observation data. These databases are built to be redundant, providing seamless failover in the case of a database failure. The services application pool 570 runs application services used for data synchronization and other internal processes such as notification creation and database logging.

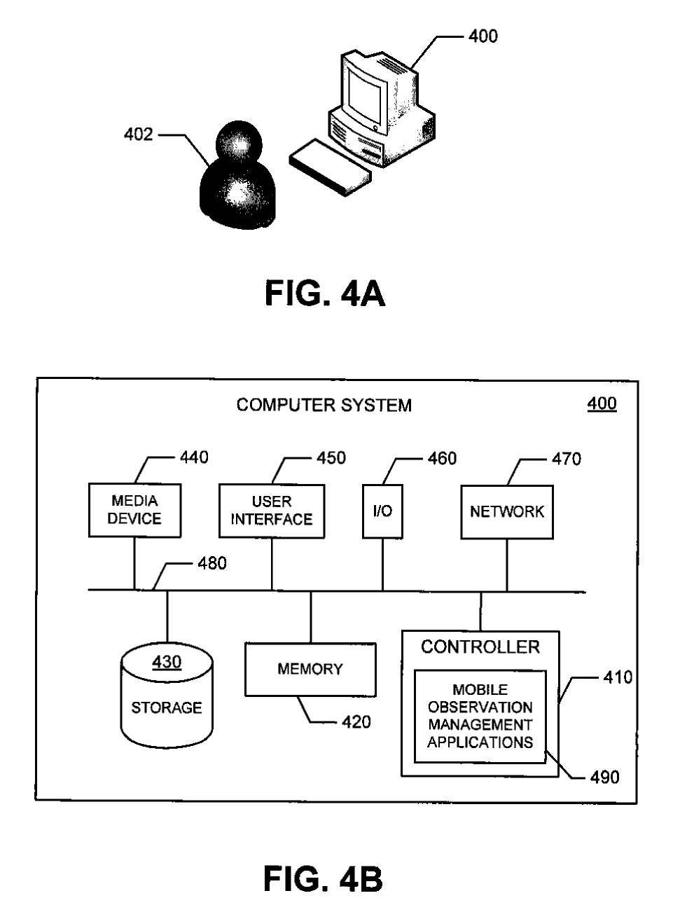

FIG. 4A illustrates a representation of a computer system 400 and a user 402. The user 402 uses the computer system 400 to provide mobile observation management. The computer system 400 stores and executes mobile observation management applications 490.

FIG. 4B is a functional block diagram illustrating the computer system 400 hosting the mobile observation management applications 490. The controller 410 is a programmable processor and controls the operation of the computer system 400 and its components. The controller 410 loads instructions (e.g., in the form of a computer program) from the memory 420 or an embedded controller memory (not shown) and executes these instructions to control the system. In its execution, the controller 410 provides the mobile observation management applications 490 as a software system. Alternatively, this service can be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data temporarily or long term for use by other components of the computer system 400, such as for storing data used by the mobile observation management applications 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user 402. In one implementation, the user interface 450 includes a keyboard, a mouse, audio speakers, and a display. The controller 410 uses input from the user to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45, “Wi-Fi” interface, Bluetooth, WAN, or cellular data service (including, but not limited to 802.11) supporting an Ethernet connection.

A system communication path 480 (e.g., a system communication bus) provides for transfers of data and control information between the media device 440, user interface 450, I/O interface 460, network interface 470, storage 430, memory 420, and controller 410.

The computer system 400 includes additional hardware and software typical of computer systems (e.g., power, cooling, operating system), though these components are not specifically shown in FIG. 4B for simplicity. In other implementations, different configurations of the computer system can be used (e.g., different bus or storage configurations or a multi-processor configuration).

Various implementations of the invention are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a computer-readable storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Additionally, the steps of a method or technique described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

1. A method of managing mobile observation, comprising:
customizing observation data collection including generating customized observation questions to meet particular needs of a client;
dynamically building user-generated questions in both a web application and a mobile application in such an input form as to match the customized observation questions;
collecting mobile observation data; and
resolving conflicts in the observation data by synchronizing data residing in multiple locations.

2. The method of claim 1, further comprising
preparing enterprise level reports using a software as a service deployment model.

3. The method of claim 2, further comprising
viewing the observation data and the enterprise level reports without having to login to a specific computer or request reports from others.

4. The method of claim 1, wherein generating customized observation questions employs wizard controls and graphical interfaces in the form of flow charts.

5. The method of claim 1, wherein the customized observation questions include customized inspection questions.

6. The method of claim 1, wherein customizing observation data collection comprises
using a decision-based question layout that dynamically generates follow-up questions based on answers to previous questions.

7. The method of claim 1, wherein dynamically building user-generated questions in such an input form as to match the customized observation questions comprises
preparing each question in real-time to match expected answers.

8. The method of claim 1, wherein resolving conflicts in the observation data comprises
entering the observation data once and synchronizing according to priority levels.

9. The method of claim 1, resolving conflicts in the observation data comprises
maintaining an integrity of the observation data by allowing edit record zones in only one area at a time.

10. The method of claim 9, wherein allowing edit record zones in only one area at a time comprises
protecting the observation data so that it may only be used in one specified location at any one time.

11. The method of claim 10, wherein protecting the observation data so that it may only be used in one specified location at any one time comprises
allowing alteration of the observation data at a location where the observation data is entered or edit record zone permitting.

12. A mobile observation management system, comprising
a data collection customization module to allow a user to generate customized observation questions to meet particular needs of the user;
a dynamic rendering engine to dynamically build user-generated questions in both a web application and a mobile application in such an input form as to match the observation questions that are being asked; and
a conflict resolution module to resolve conflicts in the data collected or entered in multiple locations.

13. The system of claim 12, wherein the data collection customization module uses a decision-based question layout that dynamically generates follow-up questions based on answers to previous questions.

14. A computer-readable storage medium storing a computer program for managing mobile observation, the computer program comprising executable instructions that cause a computer to:
customize observation data collection including generating customized observation questions to meet particular needs of a client;
dynamically build user-generated questions in both a web application and a mobile application in such an input form as to match the customized observation questions;
collect mobile observation data; and
resolve conflicts in the observation data by synchronizing data residing in multiple locations.

15. The computer-readable storage medium of claim 14, further comprising executable instructions that cause a computer to
prepare enterprise level reports using a software as a service deployment model.

16. The computer-readable storage medium of claim 14, wherein executable instructions that cause a computer to generate customized observation questions comprise executable instructions that cause a computer to
employ wizard controls and graphical interfaces in the form of flow charts.

17. The computer-readable storage medium of claim 14, wherein executable instructions that cause a computer to customize observation data collection comprise executable instructions that cause a computer to use a decision-based question layout that dynamically generates follow-up questions based on answers to previous questions.

18. The computer-readable storage medium of claim 14, wherein executable instructions that cause a computer to dynamically build user-generated questions in such an input form as to match the customized observation questions comprise executable instructions that cause a computer to
preparing each question in real-time to match expected answers.

19. The computer-readable storage medium of claim 14, wherein executable instructions that cause a computer to resolve conflicts in the observation data comprise executable instructions that cause a computer to
enter the observation data once and synchronize according to priority levels.

20. The computer-readable storage medium of claim 14, wherein executable instructions that cause a computer to resolve conflicts in the observation data comprise executable instructions that cause a computer to
maintain an integrity of the observation data by allowing edit record zones in only one area at a time.
